(19) United States
(12) Patent Application Publication
(10) Pub. No.: US 2026/0170301 A1
(43) Pub. Date: Jun. 18, 2026

(54) DYNAMIC DISTRIBUTED NEURAL NETWORK SYSTEMS, METHODS, AND APPARATUSES

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/420,762

(22) Filed: Dec. 16, 2025

Related U.S. Application Data
(60) Provisional application No. 63/734,206, filed on Dec. 16, 2024.

(51) Int. Cl. G06N 3/045

(52) U.S. Cl. CPC G06N 3/045

(57) ABSTRACT

The present disclosure sets forth systems, apparatuses, and methods for dynamically generating and maintaining distributed neural networks with one or more edge systems. An example system comprises a first neural network having a first set of capabilities, an edge system in network communication with the first neural network, and a second neural network configured to determine a second set of capabilities of the edge system, generate, based on the first set of capabilities of the first neural network, based on the second set of capabilities of the edge system, and based on a schema, a third neural network that is a simplified version of the first neural network, and deploy the third neural network onto the edge system.

### CROSS REFERENCE TO RELATED APPLICATIONS

This patent claims priority to and the benefit of U.S. Provisional Ser. No. 63/734,206, filed on Dec. 16, 2024, entitled “Dynamic Neural Network Distribution System for Cognition-on-the-Edge (Neuragrid).” U.S. Provisional Ser. No. 63/734,206 is hereby incorporated herein by reference in its entirety.

### FIELD OF THE DISCLOSURE

This disclosure relates generally to systems, methods, and apparatuses for providing dynamic distributed neural networks.

### BACKGROUND

Network controlled devices and software require constant communication with the network for continued performance. Network connections, however, are never constant. Network interruptions occur frequently, which impact network controlled devices and software by ceasing operations or continuing operation beyond intentions (e.g., repetitive or unstoppable performance).

### BRIEF DESCRIPTION OF THE DRAWINGS

FIG. 1 is a perspective view of an example network architecture comprising a cognitive neural network, an executable neural network, a system connect adapter neural network, and a reality access system neural network in accordance with teachings of this disclosure.

FIG. 2 is a perspective view of an example operational topology showing cognitive nodes, execution nodes, system connect adapter nodes, reality access system nodes, and connections, illustrating signal flow in accordance with teachings of this disclosure.

FIG. 3 is a block diagram of a dynamic distributed neural network system comprising a central neural network, a neuragrid, and an edge neural network deployed on one or more edge systems in accordance with the teachings of this disclosure.

FIG. 4 is a block diagram of the neuragrid of FIG. 3 in accordance with the teachings of this disclosure.

FIG. 5 is a flowchart illustrating a process performed by the neuragrid of FIG. 4 in accordance with the teachings of this disclosure.

FIG. 6 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

The systems, methods, and apparatuses of the present disclosure may optimize and offload simplified versions of a central neural network (referred to herein as an edge neural network) onto one or more edge systems for cooperation and distribution of network functions. In some examples, the central neural network and/or the edge neural network may be generative neural networks comprising numerous neurons. These neurons may be generated, adapted, modified, or eliminated dynamically in real time to constantly adapt to ever-changing inputs. Furthermore, these neurons may establish, create, adjust, ignore or block their own connections to other neurons such that the neural network adapts not only by the number of neurons, but also by their interconnections. The everchanging number of neurons and the connections therebetween enables the production of different outputs for a same given input. For example, at a first time, a signal generated based on a first input may pass through the neural network according to a first path. Subsequently at a second time after the neural network neuron configuration has changed, the same signal generated based on the first input may pass through the neural network according to a second, different path. The path that the signal takes through the neural network may cause the output produced by the same input to differ, thereby implementing non-deterministic cognition. Additionally, because a neuron may be unaware of the input data (and therefore the input is non-deterministic), the output of a single neuron itself may be non-deterministic.

Typically, neural networks can expand both in terms of execution (e.g., vertical growth) and connections (e.g., horizontal growth). However, due to hardware and other resource limitations, the more execution nodes added to a neural network, the less connections may be added (and vice a versa). In the example generative neural networks described herein, such limitations do not exist. Indeed, as described herein, multiple types of execution neurons may be added (e.g., vertical growth) to the neural network as well as new connections (e.g., horizontal growth).

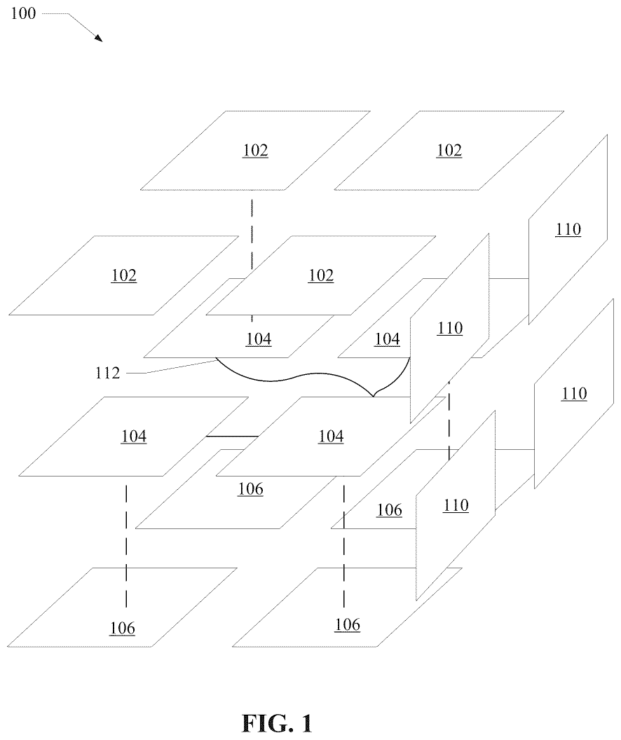

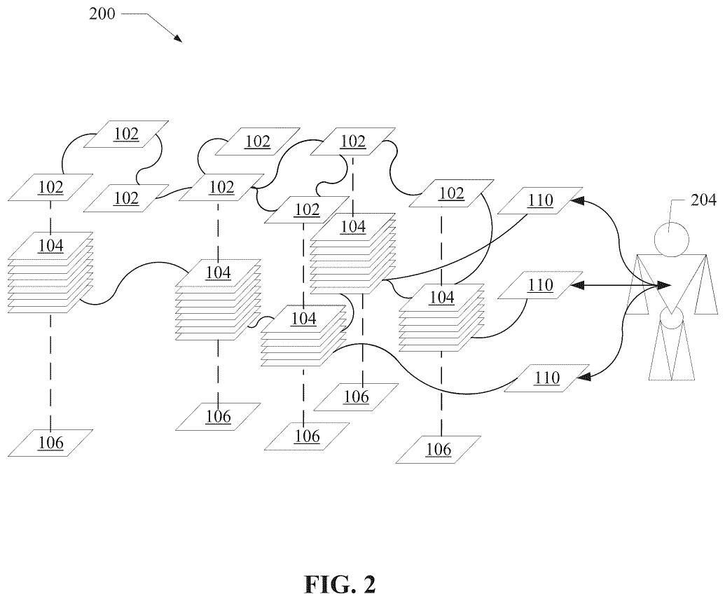

In accordance with the teachings of this disclosure, FIGS. 1-2 set forth perspective views of example generative neural networks 100, 200 comprising a number of neural nodes or instances. The exemplary illustrated neural nodes may be implemented via software as modules. In some examples, the exemplary neural nodes may be associated with corresponding hardware or portions of corresponding hardware. In some examples, each neural node may be associated with its own hardware. In some examples, the neural nodes may be implemented on a device, a system, a local area network of devices, a cloud-based network of devices, an Internet based network of devices, or any combination thereof. The generative neural networks 100, 200 may comprise a cognitive node graph runtime 102, an executable node graph runtime 104, a system connect adapter runtime 106, and a reality access system runtime 110. Each of the cognitive node graph runtime 102, the executable node graph runtime 104, the system connect adapter runtime 106, and the reality access system runtime 110 may communicate via signals via one or more connections 112. As noted above, the one or more connections 112 may be dynamically created, adapted, or blocked, such that the one or more connections 112 are not limited to those illustrated in FIG. 1.

In some examples, the cognitive node graph runtime 102 may create relationships in meanings on the neural nodes of the generative neural networks 100, 200, which may enable the neural nodes to communicate efficiently and effectively. In some examples, the cognitive node graph runtime 102 may adjust (e.g., enrich, reduce, or otherwise update) signals traveling between neurons, which may enable precise and relevant transmission of information. In some examples, the cognitive node graph runtime 102 may provide timely contextualization for LLMs, which may enable neurons to better understand and respond to changing conditions. In some examples, the cognitive node graph runtime 102 may rely on embeddings. The cognitive node graph runtime 102 may enable long-term memory storage in a compact format.

In some examples, the executable node graph runtime 104 may comprise a number of nodes that act as executable neurons within the generative neural networks 100, 200. In some examples, the nodes may act as neural logic gates, similar to AND, OR, NOT, NAND, NOR, XOR, and XNOR logic gates in digital circuits. In some examples, the nodes may comprise embeddings, API calls, and LLM GUIs (e.g., OllamaChat). In some examples, a node may communicate with an LLM at a synapse activator, during runtime, at an axion signal router, and/or during axion replication. In some examples, the executable node graph runtime 104 communicates with LLMs via the system connect adapter runtime 106. The executable node graph runtime 104 may control the structure of the generative neural networks 100, 200, including the creation, adjustment, or destruction of neurons. In order to create new neurons, the executable node graph runtime 104 may comprise a neural blueprint including a collection of existing neurons to use as a reference or baseline for the creation of the new neurons.

In some examples, the system connect adapter runtime 106 may connect various components of the generative neural networks 100, 200 to LLMs, vector databases, embeddings, static information, vector memory, API calls, deterministic logic, and the like. The example vector databases may comprise NoSQL databases optimized for vector-based data storage and retrieval. The example embeddings may comprise vector representations of words, phrases, and other entities used in natural language processing (NLP). The example static information may comprise fixed values or constants that are generally unchanging. The example vector memory may store and enable retrieval of the vector-based data. The example deterministic logic may comprise predefined logic rules or functions that may govern the behavior of the system connect adapter runtime 106.

In some examples, the reality access system runtime 110 may connect one or more neurons to the physical world via one or more interfaces. For example, the reality access system runtime 110 may interface with one or more sensors, input devices, and/or output devices. The reality access system runtime 110 may interface with one or more image sensors (e.g., cameras), audio sensors (e.g., microphones), contact sensors (e.g., haptic feedback), or the like. In some examples, the reality access system runtime 110 may interface with external reality hardware hosts 204 (FIG. 2) such as robots, security systems, appliances, mobile phones, computer networks, autonomous vehicles, and the like. In some examples, portions of the generative neural networks 100, 200 may be offloaded onto the external reality host. In some such examples, a subset of neural nodes of the generative neural networks 100, 200 may be replicated onto the external reality host. In some such examples, the subset of neural nodes may operate in parallel with corresponding neural nodes of the generative neural networks 100, 200.

In operation, the generative neural networks 100, 200 may be trained before and after deployment, in contrast to transformer-based models that can only be deployed after extensive training. The cognitive node graph runtime 102 may enable the generative neural networks 100, 200 to process and interpret incoming data (e.g., sensory information from the reality access system runtime 110) and make decisions based on that information. In some examples, the incoming data may be multimodal in that it may come from disparate types of sources (e.g., text, audio, imagery, video, or any combination thereof). In some examples, the incoming data may come from such disparate sources simultaneously and may or may not be related.

Current approaches to deploying artificial intelligence (AI) on external reality hosts or other edge devices face several significant limitations that hinder the development of truly adaptive and efficient distributed AI systems. For example, current edge devices typically operate with pre-installed, fixed neural networks that offer limited adaptability. Any updates or modifications to these models require manual intervention or complete replacement of the existing model, making it difficult to adapt to changing requirements in real-time.

Edge devices may be limited in terms of computational power, memory capacity, and energy resources. Accordingly, edge devices may require substantial simplification of complex AI models, which inevitably reduces their capabilities. The trade-offs between performance and resource usage may be determined during the design phase, but remains fixed thereafter and creates ongoing challenges in achieving an optimal balance between autonomous operation and computational efficiency.

While federated learning has enabled distributed AI training, current approaches face several fundamental limitations. For example, systems like TensorFlow Federated and PySyft primarily focus on distributed training, which require consistent model architecture across all devices (e.g., identical layer structures). Such systems have limited ability to specialize models for different roles (e.g., cannot optimize different parts of network for different devices). Additionally, these systems face major synchronization challenges in intermittent network conditions (e.g., >30% failure rate in poor connectivity).

Current federated learning approaches also struggle with model poisoning attacks. They have limited mechanisms for ensuring data privacy during model updates, and they lack standardized security protocols for edge-to-edge communication.

Popular frameworks (e.g., TensorFlow Lite, PyTorch Mobile) focus solely on model optimization, but have no standardized approach for managing distributed cognitive functions. And their runtime adaptation capabilities are limited to basic parameter updates.

Current fleet management systems face significant challenges in coordinating devices with varying capabilities and specifications. The lack of standardized protocols for managing heterogeneous device networks makes it difficult to effectively orchestrate multi-device operations. Additionally, these systems provide no robust mechanisms for dynamically reassigning roles and responsibilities as conditions change, severely limiting their adaptability and resilience.

Existing distributed systems exhibit limitations in handling network connectivity issues. During network outages, most systems struggle to maintain autonomous operations, often resulting in degraded functionality or complete failure. When devices reconnect after periods of disconnection, complex synchronization challenges emerge as systems attempt to reconcile divergent states and operation histories. Furthermore, these systems lack effective mechanisms for maintaining consistent system states across disconnected devices, leading to potential conflicts and data inconsistencies when connectivity is restored.

Optimization techniques are often applied pre-deployment with no runtime adaptation, limiting the ability to adapt model architecture to different hardware capabilities.

And current system architectures impose significant constraints that limit the effectiveness of edge AI deployments. The rigid boundaries between edge and cloud computing create artificial barriers that prevent seamless distribution of computational workloads. Existing systems often lack the flexibility to dynamically redistribute processing tasks based on changing conditions and requirements. Additionally, the absence of a standardized framework for managing devices with diverse capabilities makes it extremely challenging to effectively coordinate heterogeneous edge systems. These fundamental architectural limitations underscore the pressing need for a more flexible and dynamic approach to deploying AI capabilities across edge devices. The current solutions available in the market fail to provide the necessary functionality and adaptability required for truly effective edge AI systems.

The present systems, methods, and apparatuses, in contrast, provide real-time generation and deployment of specialized neural networks optimized for specific devices and tasks. The present systems, methods, and apparatuses enable dynamic distribution and redistribution of cognitive functions across heterogeneous device networks. And the present systems, methods, and apparatuses provide seamless operation and synchronization in environments with intermittent connectivity.

In some examples, the systems, methods, and apparatuses disclosed herein transfer only the minimally required neural components onto edge systems, unlike traditional systems that deploy full models. The systems, methods, and apparatuses disclosed herein modify neural architectures on-the-fly without system restarts. The systems, methods, and apparatuses disclosed herein automatically tailor edge neural networks to each edge device's computational capabilities.

In some examples, the central neural network can direct edge devices to update or instantly switch functions by transmitting new specialized neural networks. In some examples, the central neural network may update only affected neural components rather than entire models on the edge systems.

In some examples, the systems, methods, and apparatuses disclosed herein may split complex neural processing across multiple edge devices (as well as the central neural network). In some such examples, computational load may be distributed across the edge devices based on device capabilities and/or network conditions.

In some examples, the edge systems may maintain core functionality during network disconnection, and may automatically reconcile autonomous operations when connectivity resumes. During network disconnection, critical operations (e.g., fine-grained movement, reactive behaviors, or other responses to immediate threats or opportunities) may continue to run locally, eliminating network round-trip delays,

The systems, methods, and apparatuses disclosed herein may be applicable in many industries including, for example, unmanned vehicles and robotics, logistics and delivery, consumer electronics, and/or autonomous vehicles. For example, a central neural network may dynamically deploy specialized AI capabilities to unmanned vehicles and robotics for strategic operations. In some examples, a central neural network may adapt delivery drones in real-time due to changing logistical demands. In some examples, a central neural network may enhance smartphones and wearables with updated, context-specific and offline-capable AI features without hardware changes. In some examples, a central neural network may update vehicle AI systems on-the-fly to adapt to new driving environments or regulations.

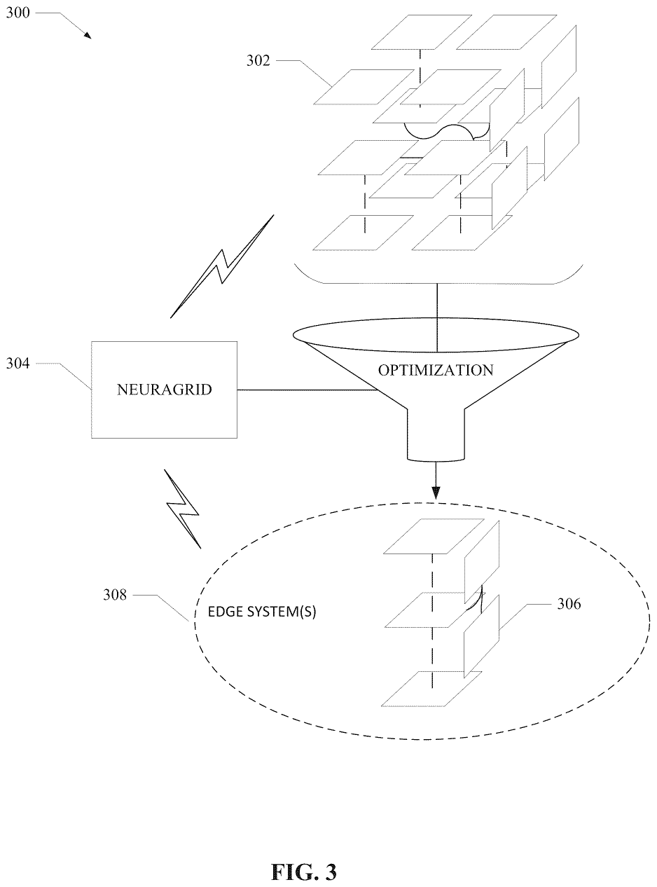

FIG. 3 illustrates an example system 300 comprising a central neural network (CNN) 302, a neuragrid 304, and an edge neural network (ENN) 306. In some examples, the CNN 302 may be a powerful neural network running on one or more data centers or servers. In some examples, the CNN 302 may possess capabilities such as complex cognitive functions, emotions, memories, and a wide range of skills. In some examples, the CNN 302 may be an implementation of the neural networks 100, 200. The example neuragrid 304 may be part of and/or may communicate with the CNN 302. The example neuragrid 304 may be an optimized neural network for determining what portions of the CNN 302 are needed for a given edge system 308. The example neuragrid 304 may dynamically generate and deploy ENNs 306 to network-operated devices or services (edge systems 308) as required. In some examples, the CNN 302—ENN 306 relationship may be a master-slave architecture, with the CNN 302 being the master and the ENN 306 being the slave. In some such examples, the CNN 302 may, as the master, coordinate the deployment of various slave ENNs 306 across numerous edge systems 308. As an example, an autonomous ride share company may be run by a CNN 302 that deploys various ENNs 306 to be run on various autonomous vehicles. In some such examples, the CNN 302 may accept user requests, determine available autonomous vehicles near the user, determine navigation to the user, determine closest autonomous vehicle in terms of travel time, determine navigation from the user to the user's destination, and deploy an ENN 306 to the closest autonomous vehicle for navigating to the user and getting the user to his or her destination. In some such examples, the ENN 306 may handle the navigation steps (e.g., navigate to user, navigate from user location to destination) with or without communication with the CNN 302. In some examples, the ENN 306 may perform rudimentary decision making tasks like determining an amount of time to wait for a user to enter the autonomous vehicle once it arrives at the user's location, determining whether a user has boarded the vehicle, determining whether the user is safely secured (e.g., seat belt has been fastened), starting the vehicle, determining a speed limit, accelerating comfortably to the speed limit, stopping at stop signs and lights, decelerating comfortably into a stop, signaling turns or lane changes, obstacle avoidance, remaining a certain number of car lengths behind other vehicles, etc.

Example edge systems 308 may comprise physical or virtual systems with varying computational capabilities (e.g., drones, smartphones, virtual environments, biological interfaces, etc.). In some examples, an edge system 308 may execute the ENN 306 to augment the functionality of the CNN 302. In some such examples, multiple ENNs 306 may be deployed to distribute various functionalities of the CNN 302 across various edge systems 308. In some examples, an edge system 308 may operate independently from the CNN 302. In some examples, the neuragrid 304 may optimize the ENN 306 according to specific capabilities of an edge system 308.

In some examples, the neuragrid 304 may generate an ENN 306 as a reduced version of the CNN 302 to be deployed on edge systems. As illustrated in FIG. 3, the neuragrid 304 may optimize a version of the CNN 302 for implementation on a specific edge system 308. In some examples, the neuragrid 304 may create an ENN 306 based on goals or objectives to be achieved by the edge system 308 on behalf of the CNN 302. For example, if the edge system is a drone, the neuragrid 304 may optimize an ENN 306 to handle navigation, autonomous obstacle avoidance, emergency landing procedures, or the like. In some such examples, the ENN 306 may exclude some of the CNN 302 capabilities such as complex cognitive functions, emotions, memories, etc. The ENN 306 may operate in communication with the CNN 302. The ENN 306 may additionally operate with minimal or no communication with the CNN 302.

In some examples, the ENN 306 may be considered a shadow neural network of the CNN 302. In some examples, a shadow neural network may be a temporary representation of a subset of a larger neural network (e.g., the CNN 302), configured to execute specific capabilities locally on a remote device (e.g., the edge system 308). In contrast to the CNN 302, the shadow ENN 306 may be a dependent neural network that may not evolve on its own. In some such examples, the shadow ENN 306 may be a buffer of decision-making capability residing on the edge system 308. When the edge system 308 is connected to the CNN 302, the shadow ENN 306 may be synchronized in real time with the corresponding portions of the CNN 302. When the edge system 308 is disconnected from the CNN 302, the shadow ENN 306 may continue execution based on its pre-loaded capabilities.

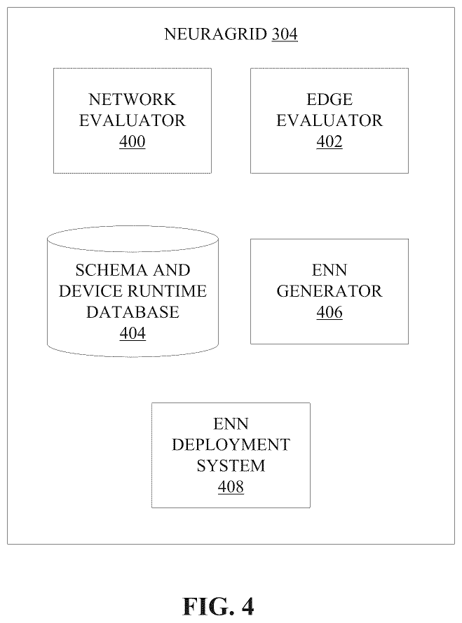

FIG. 4 is a block diagram of an example neuragrid 304. In some examples, the neuragrid 304 may comprise a network evaluator 400, an edge evaluator 402, a schema and device runtime database 404, an ENN generator 406, and an ENN deployment system 408. The example network evaluator 400 may determine the current capabilities of the CNN 302. In some examples, the CNN 302 may evolve over time to obtain new capabilities. Accordingly, the network evaluator 400 may determine any and all, including new, capabilities of the CNN 302, which may become a pool for which the ENN generator 406 may use when generating ENNs 306. The example network evaluator 400 may also determine a status of the CNN 302 for comparison with one or more statuses of the edge systems 308 in order to determine whether the CNN 302 is synchronized with the various ENNs 306 within the edge systems 308. In some examples, the status of the CNN 302 may be a current state, an event history, or a combination thereof.

The example edge evaluator 402 may perform a handshake with the edge system 308 to determine the capabilities of the edge system 308. In some examples, during the handshake, the edge system 308 may communicate to the edge evaluator 402 whether it has the capability to support an offload runtime for executing ENNs 306, and may provide a specification of how much execution runtime capability it can support. In some examples, if the edge system 308 does not support the offload runtime or its capabilities do not meet minimum requirements, the neuragrid 304 may not offload an ENN 306 to that edge system 308. In some examples, the edge evaluator 402 may determine the environmental context around the edge system 308. The edge evaluator 402 may further determine one or more tasks to be accomplished by the edge system 308 and/or any requirements for such tasks. In some examples, the edge evaluator 402 may determine one or more cognitive functions needed to perform the one or more tasks. In some examples, the edge evaluator 402 may determine the qualities of other connected systems. In some such examples, the edge evaluator 402 may determine, based on the above, roles, constraints, capabilities of the edge system, and real-time performance optimization opportunities. The edge evaluator 402 may also determine a status of an ENN 306 on an edge system 308 in order to determine whether the ENN 306 is synchronized with the CNN 302. In some examples, the status of the ENN 306 may be a current state, an event history, or a combination thereof. In examples where the status of the ENN 306 is determined to be unsynchronized with the CNN 302 (e.g., due to the ENN 306 losing network connectivity), the edge evaluator 402 may communicate any missing data, events, etc. to the CNN 302 for synchronization. In some examples, this synchronization may occur each time the ENN 306 connects to the CNN 302. In some examples, the sharing of new data and experiences from the period of network disconnection may improve overall system intelligence. In some examples, when the ENN 306 reconnects to the CNN 302, the perceptions, state changes, and accumulated experiences from the period of disconnection may be uploaded to the CNN 302 and integrated into the CNN 302 as part of its memory. In some such examples, the CNN 302 may process the uploaded data as if the CNN 302 had directly experienced the events during the period of disconnection.

The example schema and device runtime database 404 may store a standardized schema for normalizing compatibility between the CNN 302 and the various edge systems. In some examples, the schema may be a common format that identifies the packaging and unpackaging semantics for ENNs 306. This schema may ensure that any neural network conforming to it can interact with the systems, methods, and apparatuses described herein. In some examples, the schema and device runtime database 404 may store device-optimized runtimes. In some examples, the schema and device runtime database 404 may store edge runtimes for unpacking and executing ENNs 306 on edge systems 308.

The ENN generator 406 may generate ENNs 306 of the CNN 302 that focus on specific capabilities (e.g., visual processing, pathfinding, emotional intelligence) while deliberately excluding others to optimize performance and reduce computational overhead. In some examples, ENNs 306 may be precisely tailored to both the hardware constraints and functional requirements of each edge system and its role in the network. In some examples, the ENN generator 406 may optimize an ENN 306 for system-specific capabilities and constraints. These ENNs 306 may either augment the functionality of the CNN 302 or operate independently. In some examples, the ENN generator 406 may select essential functions suitable for a role of a target edge system 308 in the CNN 302. In some examples, the CNN 302 may dictate the capabilities of an ENN 306. In some examples, the ENN generator 406 may exclude unnecessary capabilities of the CNN 302 within an ENN 306 to optimize performance. The ENN generator 406 may balance a level of autonomy with connectivity requirements.

The ENN deployment system 408 may select, compact, and transfer specific ENNs 306 or simplified/specialized variants of its neural network to target systems based on their capabilities and current tasks. In some examples, the ENN 306 may be a specialized neural architecture that is compacted into a compressed format and transferred to the target systems using available network connections. In some examples, the ENN deployment system 408 may transmit new ENNs 306 on demand, allowing the edge systems 308 to change roles and behaviors instantly as directed by the CNN 302.

In some examples, the ENN deployment system 408 may transmit an edge runtime to be run on an edge system 308. In some examples, the edge runtime may be optimized for specific hardware and may be capable of unpacking and executing the transmitted ENNs 306. In some such examples, the edge runtime and the ENNs 306 may transform the edge system 308 into an extension of the CNN 302.

In some examples, the ENN deployment system 408 may send an ENN 306 as software to be downloaded by the edge system 308. In some examples, the edge system 308 may have to initiate the download and installation of the ENN 306. In some examples, the edge runtime may automatically download, unpack, deploy, and begin executing the newly received neural architecture. In some examples, the ENN 306 may allow an edge system 308 to perform tasks semi-autonomously, either as extensions of the CNN 302 or independently when connectivity is lost.

In some examples, the ENN 306 may be updated or otherwise replaced at an edge system 308. In some examples, the ENN deployment system 408 may transmit a new ENN 306. In some examples, the ENN deployment system 408 may transmit an update to the ENN 306. In some examples, when an edge system 308 receives an update to the ENN 306, such as changes to account for new environmental factors, the edge system 308 may, via the edge runtime, deploy these changes without requiring a restart or shutdown of the ENN 306. In some such examples, the ENN 306 may continue to process ongoing signals uninterrupted or with minimal delay. In some examples, signals may be temporarily slowed to accommodate the deployment of new architecture components before resuming normal processing through the updated regions.

In operation, the neuragrid 304 may deploy a number of ENNs 306 across a varying number of edge systems 308 (e.g., a plurality of drones each potentially running different ENNs), enabling the CNN 302 to scale its operations dynamically. In some examples, where one or more edge systems 308 lose network connection to the CNN 302, the edge runtime on the edge system 308 may detect the network disruption and automatically activate the ENN 306 for autonomous operation. In some examples, the edge runtime may detect the signal drop from the CNN 302 and switch to the locally-stored ENN 306 almost immediately (e.g., within milliseconds). The one or more edge systems 308 may then operate autonomously based on the ENN 306, resuming execution from where the edge system 308 was before the communication was interrupted. In some examples, an edge system 308 may synchronize with the CNN 302 when network connection resumes. In some examples, a first edge system 308 may synchronize with the CNN 302 via a second edge system 308 that has network connection with the CNN 302.

In some examples, the ENN 306 may have limited reasoning capacity compared to the CNN 302. When the ENN 306 encounters a situation beyond its pre-planned capabilities, the ENN 306 may execute a fallback behavior. In some examples, the fallback behavior may comprise returning the edge system 308 to a base location, entering a safe mode, or performing other predefined safety protocols. In some examples, if the edge system 308 regains network connectivity with the CNN 302 before executing the fallback behavior, the ENN 306 may send a signal to the CNN 302 indicating it requires assistance, and the CNN 302 may transmit an updated ENN 306 with additional capabilities to address the situation.

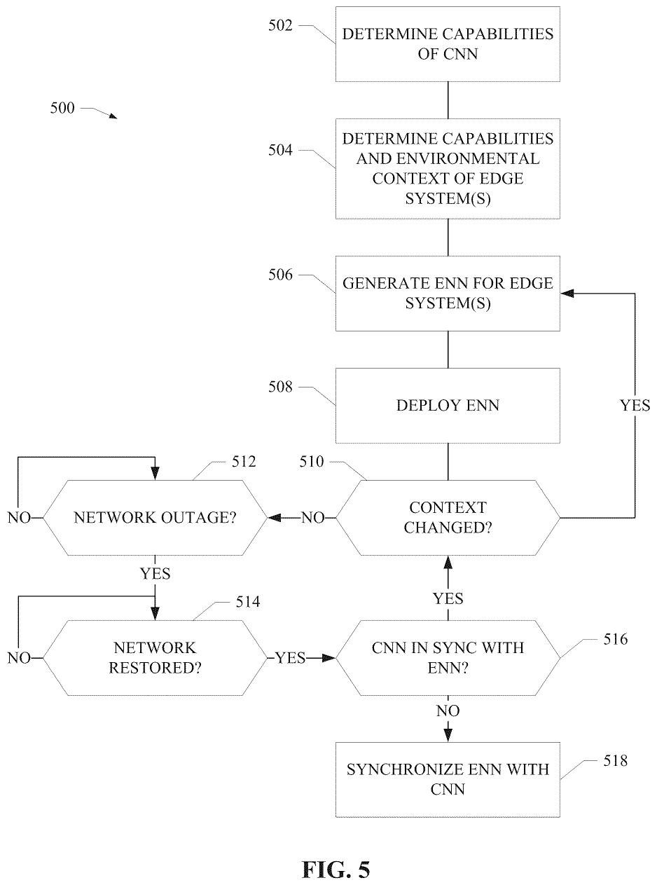

FIG. 5 is a flowchart of a process 500 for generating and deploying an ENN 306. The process 500 may begin at step 502 where the network evaluator 400 determines the capabilities of the CNN 302. At step 504, the edge evaluator 402 may determine the capabilities and environmental context of one or more edge systems 308. The example ENN generator 406 may determine, based on the capabilities of the CNN 302, the capabilities and environmental context of one or more edge systems 308, one or more tasks to be performed by the one or more edge systems 308, and/or based on a schema, an ENN 306 at step 506. In some examples, the determined ENN 306 may be a simplified version of the CNN 302 specifically optimized for the one or more edge systems 308 or the tasks to be performed by the one or more edge systems 308. At step 508, the ENN deployment system 408 may deploy the determined ENN 306 to the one or more edge systems 308. In some examples, the ENN deployment system 408 transmits the ENN 306 to the one or more edge systems 308 with an edge runtime to unpack and install the ENN 306 on the one or more edge systems 308.

At step 510, the edge evaluator 402 may determine whether or not any edge system 308 context changes have occurred. For example, one or more environmental aspects may have changed such as the edge system 308 being in an unknown location. In some examples, the network evaluator 400 may also determine whether or not any CNN 302 context changes have occurred. For example, the CNN 302 may no longer require the ENN 306 to perform a task for which it was generated. If there are any context changes (step 510: YES), the process 500 may return to step 506, where a new ENN 306 (or an update to the ENN 306) is generated based on the changed context. If there are no context changes (step 510: NO), the process 500 may proceed to step 512. Although step 510 is illustrated as occurring after step 508 and before step 512, step 510 may occur at any time.

At step 512, the edge evaluator 402 may determine whether or not the one or more edge systems 308 has lost network connection with the CNN 302. For example, the edge evaluator 402 may ping the one ore more edge systems 308 and if the edge evaluator 402 does not respond after a threshold amount of time, the edge evaluator may determine the one or more edge systems 308 have lost network connection. Alternatively, the one or more edge systems 308 may constantly send a signal to the edge evaluator 402, and after not receiving the signal for over a threshold amount of time, the edge evaluator 402 may determine that the one or more edge systems 308 have lost network connection. The edge evaluator 402 may communicate with the network evaluator 400 to determine if the CNN 302 and the ENN 306 are out of synchronization due to a network disconnection. If the edge evaluator 402 determines that the one or more edge systems 308 have not lost network connection (step 512: NO), the process 500 may continue to evaluate for future network connection losses. In some examples, the process 500 may cease so as not to loop forever. If the edge evaluator 402 determines that the one or more edge systems 308 have lost network connection (step 512: YES), the process 500 may proceed to step 514.

At step 514, the edge evaluator 402 may determine whether the network connection between the ENN 306 and the CNN 302 has been restored. If the network connectivity has not been restored (step 514: NO), the process 500 may continue to evaluate for future network connectivity. In some examples, the process 500 may loop at step 514 until the ENN 306 reconnects with the CNN 302. If the network connectivity has been restored (step 514: YES), the process 500 may proceed to step 516. At step 516, the edge evaluator 402 may determine a state or event history of the ENN 306. In some examples, the edge evaluator 402 may communicate with the network evaluator 400 to determine if the CNN 302 has a different state or event history from the ENN 306, or if the CNN 302 and the ENN 306 are in sync. If the CNN 302 is in sync with the ENN 306 (step 516: YES), then the process 500 may return to step 510. If the CNN 302 is not in sync with the ENN 306 (step 516: NO), then the edge evaluator 402 may determine the difference in the state or event history of the ENN 306, and transmit the difference to the CNN 302 to synchronize the ENN 306 with the CNN 302 (step 518). The process 500 may be run any number of times for any number of edge systems 308.

As a real world example, a fleet of twenty identical drones may each be equipped with the same hardware capabilities. While traditional systems may deploy identical AI software with potentially slightly different parameters to each drone, the neuragrid 304 enables the CNN 302 to treat each drone as a blank canvas, programming specialized ENNs 306 optimized for specific cognitive functions.

When operating in environments with potential connectivity loss, the neuragrid 304 may generate stripped-down ENNs 306 that prioritize mission-critical functions while deliberately excluding non-essential capabilities. For example, a subset of drones (e.g., 12) may be basic autonomous units with minimal ENNs focused solely on core navigation, obstacle avoidance, and basic mission execution logic, while deliberately excluding improvisational abilities, emotional intelligence, and communication protocols. In some such examples, these drones may be optimized for reliable mission completion even when disconnected.

When device-to-device connectivity is available, the neuragrid 304 may distribute different cognitive functions across the fleet, effectively creating a distributed “brain” where each drone specializes in specific neural processes. For example, the neuragrid 304 may generate and transmit a first ENN 306 to a first subset of drones (e.g., 3) focused on advanced navigation, route optimization, and strategic decision-making capabilities. In some examples, the first set of drones may be configured for minimal sensor processing overhead and may communicate with other drones, acting as leaders.

The neuragrid 304 may generate and transmit a second ENN 306 to a second subset of drones (e.g., 3) focused on enhanced visual/sensor data processing and real-time environmental analysis. In some such examples, the second subset of drones may have reduced navigation complexity, following pathfinding leaders. The second subset of drones may communicate with other drones, acting as perception specialists.

The neuragrid 304 may generate and transmit a third ENN 306 to a third subset of drones (e.g., 2) focused on advanced problem-solving/improvisation capabilities and complex decision trees and scenario analysis. In some such examples, the third subset of drones may have minimal movement control, focusing on pure computation. The third subset of drones may communicate with other drones, acting as cognitive processing units.

The neuragrid 304 may generate and transmit a fourth ENN 306 to a fourth subset of drones (e.g., 12) focused on simplified navigation (following leader drones). The fourth subset of drones may have minimal cognitive overhead and may be optimized for efficient execution of received commands.

This distributed approach may allow the fleet to function as an interconnected neural network, where each drone effectively serves as a specialized “brain region.” In some examples, the neuragrid 304 may dynamically allocate cognitive responsibilities based on current mission requirements, environmental conditions, available device-to-device connectivity, real-time processing needs, and computational constraints of the devices. The neuragrid 304 may redistribute these roles in real-time (e.g., based on instruction from the CNN 302), adapting the collective capabilities of the fleet as mission parameters change or if certain units become unavailable.

In some examples, the edge systems 308 may communicate directly with each other in addition to communicating with the CNN 302. In some examples, if a first edge system 308 loses network connectivity with the CNN 302 but maintains local connectivity with a second edge system 308, the first edge system 308 may communicate with the CNN 302 through the second edge system 308. In some examples, if an edge system 308 goes permanently offline (e.g., is destroyed or experiences critical failure), other edge systems 308 in proximity may detect the offline status and send a distress signal to the CNN 302. In some examples, the other edge systems 308 may adjust their ENNs 306 based on pre-planned strategies for operating with reduced fleet capacity. In some such examples, the CNN 302 may initiate the transmission, via the neuragrid 304, of new or adjusted ENNs 306 based on the loss of one of the edge systems 308.

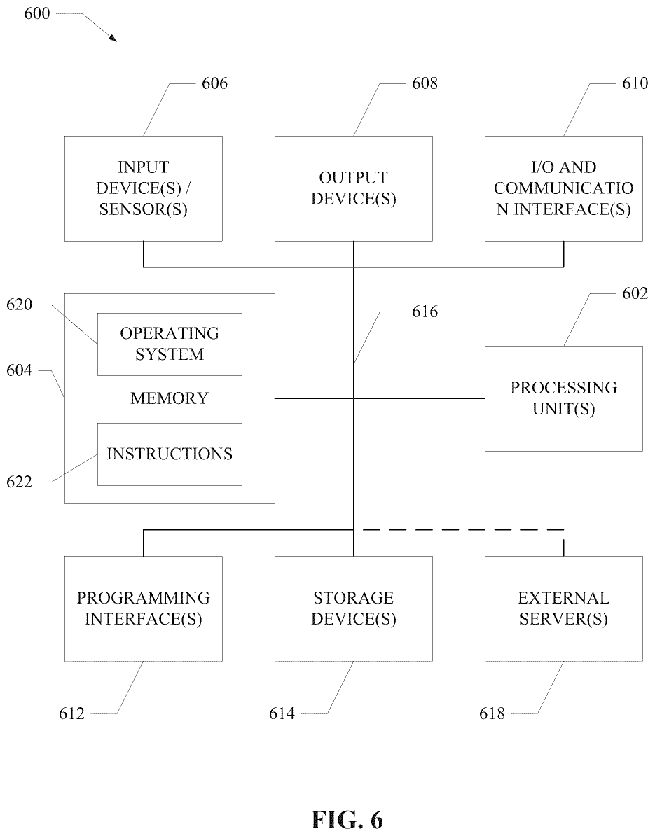

FIG. 6 illustrates an example computing device 600 that may be used in accordance with the teachings described herein. The example computing device 600 may be a computer, a tablet, a mobile device, a server, a workstation, an internet-of-things (IoT) device, a smart appliance, a network node, a hub, a router, a modem, or the like. The example computing device 600 may comprise one or more processing units 602, one or more memory 604, one or more input devices or sensors 606, one or more output devices 608, one or more input/output (I/O) and communication interfaces 610, one or more programming interfaces 612, and one or more storage devices 614. Each of the one or more processing units 602, one or more memory 604, one or more input devices or sensors 606, one or more output devices 608, one or more input/output (I/O) and communication interfaces 610, one or more programming interfaces 612, and one or more storage devices 614 may be interconnected via wired connections such as, for example, a bus 616. Alternatively, each of the one or more processing units 602, one or more memory 604, one or more input devices or sensors 606, one or more output devices 608, one or more input/output (I/O) and communication interfaces 610, one or more programming interfaces 612, and one or more storage devices 614 may be interconnected wirelessly. In some examples, each of the one or more processing units 602, one or more memory 604, one or more input devices or sensors 606, one or more output devices 608, one or more input/output (I/O) and communication interfaces 610, one or more programming interfaces 612, and one or more storage devices 614 may be interconnected via a combination of wired and wireless connections. In some examples, the example computing device 600 may be connected to one or more external servers 618.

In some examples, the processing unit 602 may be a processor such as a central processing unit (CPU), a microprocessor, integrated circuit (IC), an application-specific integrated circuit (ASIC), a Field Programmable Gate Array (FPGA), or a graphical processing unit (GPU). In some examples, the computing device 600 may have one or more processing units 602 for parallel processing. In some such examples, the one or more processing units 602 may be of the same type (e.g., multiple microprocessors). In some examples, the one or more processing units 602 may be of different types (e.g., at least one CPU and at least one GPU).

In some examples, the memory 604 may be a non-transitory computer readable storage medium. In some examples, the memory 604 may include random-access memory, such as DRAM, SRAM, DDR RAM, or other random-access solid-state memory devices. In some examples, the memory 604 may include an operating system 620 and instructions 622.

The operating system 620 may be a traditional operating system that relies on pre-defined rules and structures such as, for example, Microsoft Windows®, Linux, macOS, etc. The operating system 620 may be able to function effectively on a wide range of devices and platforms including smartphones, tablets, desktops, servers, etc. In some examples, the operating system 620 may be decentralized, such that users may share resources and may collaborate without reliance on centralized servers.

The instructions 622 may comprise computer executable instruction sets for implementing the exemplary neuragrid 304 and process 500 described above with reference to FIGS. 3-5.

In some examples, the one or more input devices or sensors 606 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 608 may comprise one or more displays, one or more speakers, one or more lights (e.g., light emitting diodes), a signal generator, a haptics engine, a printer, or the like.

In some examples, the one or more I/O and communication interfaces 610 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 612 may comprise software for implementing one or more physical I/O and communication interfaces, application programming interfaces (APIs) configured for communication with and providing services to databases, software applications, the Internet, or the like.

In some examples, the one or more storage devices 614 may comprise non-volatile memory, such as one or more magnetic disk storage devices, optical disk storage devices, flash memory devices, or other non-volatile solid-state storage devices. In some examples, the one or more storage devices 614 may include one or more databases.

In some examples, the one or more external servers 618 may comprise external processing and storage that may be utilized by the example computing device 600. In some examples, the one or more external servers 618 may be configured similarly to the example computing device 600.

One or more example apparatus, systems, and computer-readable storage mediums are described below. An example method may comprise determining a first set of capabilities of an edge system in network communication with a first neural network having a second set of capabilities and generating, based on the first set of capabilities of the edge system, based on the second set of capabilities of the first neural network, and based on a schema, a second neural network that is a simplified version of the first neural network.

Some methods further comprise deploying the second neural network onto the edge system.

In some methods, the edge system is a first edge system. Some such methods further comprise determining a third set of capabilities of a second edge system, generating, based on the second set of capabilities of the first neural network, based on the first set of capabilities of the first edge system, based on the third set of capabilities of the second edge system, and based on the schema, a third neural network that is a simplified version of the first neural network and differs from the second neural network, and deploying the third neural network onto the second edge system.

Some methods further comprise generating the second neural network based on environmental context around the edge system or one or more tasks that the edge system is to perform.

Some methods further comprise determining that the second neural network is unsynchronized with the first neural network after a period of the second neural network being disconnected from the first neural network, and upon the second neural network connecting to the first neural network, synchronizing the second neural network with the first neural network.

Some methods further comprise transmitting an edge runtime to the edge system, wherein the edge runtime may be configured to unpack and execute the second neural network on the edge system.

Some methods further comprise updating the second neural network by generating, based on the first set of capabilities of the edge system, based on the second set of capabilities of the first neural network, based on new environmental factors, and based on the schema, an updated second neural network, and deploying the updated second neural network onto the edge system.

Example apparatuses may comprise one or more processors and memory storing instructions that, when executed by the one or more processors, cause performance of any of the above methods.

Example computer readable storage mediums may be non-transitory and may store instructions that, when executed, cause performance of any of the above methods.

Example systems may comprise one or more neural networks configured to perform any of the above methods.

Other example systems may comprise a first neural network having a first set of capabilities, an edge system in network communication with the first neural network, and a second neural network having a second set of capabilities for generating one or more simplified neural networks.

In some such systems, the second neural network may be configured to determine one or more capabilities of the edge system, generate, based on the first set of capabilities of the first neural network, based on the one or more capabilities of the edge system, and based on a schema, a third neural network that is a simplified version of the first neural network, and deploy the third neural network onto the edge system.

In some systems, the edge system is a first edge system, and the systems further comprise a second edge system. In some such systems, the second neural network may be configured to determine one or more capabilities of the second edge system, generate, based on the first set of capabilities of the first neural network, based on the one or more capabilities of the first edge system, based on the one or more capabilities of the second edge system, and based on the schema, a fourth neural network that is a simplified version of the first neural network and differs from the third neural network, and deploy the fourth neural network onto the second edge system.

In some systems, the second neural network may be configured to generate the third neural network further based on environmental context around the edge system.

In some systems, the second neural network may be configured to generate the third neural network further based on one or more tasks that the edge system is to perform.

In some systems, the second neural network may be further configured to determine that the third neural network is unsynchronized with the first neural network after a period of the third neural network being disconnected from the first neural network, and upon the third neural network connecting to the first neural network, synchronize the third neural network with the first neural network.

In some systems, the second neural network may be further configured to transmit an edge runtime to the edge system, wherein the edge runtime may be configured to unpack and execute the third neural network on the edge system.

In some systems, the second neural network may be configured to update the third neural network by generating, based on the first set of capabilities of the first neural network, based on the one or more capabilities of the edge system, based on new environmental factors, and based on the schema, an updated third neural network, and deploying the updated third neural network onto the edge system.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
a first neural network having a first set of capabilities;
an edge system in network communication with the first neural network; and
a second neural network having a second set of capabilities for generating one or more simplified neural networks, wherein the second neural network is configured to:
determine one or more capabilities of the edge system;
generate, based on the first set of capabilities of the first neural network, based on the one or more capabilities of the edge system, and based on a schema, a third neural network that is a simplified version of the first neural network; and
deploy the third neural network onto the edge system.

2. The system of claim 1, wherein the edge system is a first edge system, the system further comprising a second edge system, wherein the second neural network is further configured to:
determine one or more capabilities of the second edge system;
generate, based on the first set of capabilities of the first neural network, based on the one or more capabilities of the first edge system, based on the one or more capabilities of the second edge system, and based on the schema, a fourth neural network that is a simplified version of the first neural network and differs from the third neural network; and
deploy the fourth neural network onto the second edge system.

3. The system of claim 1, wherein the second neural network is configured to generate the third neural network further based on environmental context around the edge system.

4. The system of claim 1, wherein the second neural network is configured to generate the third neural network further based on one or more tasks that the edge system is to perform.

5. The system of claim 1, wherein the second neural network is further configured to:
determine that the third neural network is unsynchronized with the first neural network after a period of the third neural network being disconnected from the first neural network; and upon the third neural network connecting to the first neural network, synchronize the third neural network with the first neural network.

6. The system of claim 1, wherein the second neural network is further configured to transmit an edge runtime to the edge system, wherein the edge runtime is configured to unpack and execute the third neural network on the edge system.

7. The system of claim 1, wherein the second neural network is configured to update the third neural network by:
generating, based on the first set of capabilities of the first neural network, based on the one or more capabilities of the edge system, based on new environmental factors, and based on the schema, an updated third neural network; and
deploying the updated third neural network onto the edge system.

8. A computer readable storage medium storing instructions that, when executed, cause:
determining a first set of capabilities of an edge system in network communication with a first neural network having a second set of capabilities;
generating, based on the first set of capabilities of the edge system, based on the second set of capabilities of the first neural network, and based on a schema, a second neural network that is a simplified version of the first neural network; and
deploying the second neural network onto the edge system.

9. The storage medium of claim 8, wherein the edge system is a first edge system, the instructions, when executed, further cause:
determining a third set of capabilities of a second edge system;
generating, based on the second set of capabilities of the first neural network, based on the first set of capabilities of the first edge system, based on the third set of capabilities of the second edge system, and based on the schema, a third neural network that is a simplified version of the first neural network and differs from the second neural network; and
deploying the third neural network onto the second edge system.

10. The storage medium of claim 8, the instructions, when executed, cause generating the second neural network based on environmental context around the edge system.

11. The storage medium of claim 8, the instructions, when executed, cause generating the second neural network based on one or more tasks that the edge system is to perform.

12. The storage medium of claim 8, the instructions, when executed, cause:
determining that the second neural network is unsynchronized with the first neural network after a period of the second neural network being disconnected from the first neural network; and
upon the second neural network connecting to the first neural network, synchronizing the second neural network with the first neural network.

13. The storage medium of claim 8, the instructions, when executed, cause:
transmitting an edge runtime to the edge system, wherein the edge runtime is configured to unpack and execute the second neural network on the edge system.

14. The storage medium of claim 8, the instructions, when executed, cause updating the second neural network by:
generating, based on the first set of capabilities of the edge system, based on the second set of capabilities of the first neural network, based on new environmental factors, and based on the schema, an updated second neural network; and
deploying the updated second neural network onto the edge system.

15. A method comprising:
determining a first set of capabilities of an edge system in network communication with a first neural network having a second set of capabilities;
generating, based on the first set of capabilities of the edge system, based on the second set of capabilities of the first neural network, and based on a schema, a second neural network that is a simplified version of the first neural network; and
deploying the second neural network onto the edge system.

16. The method of claim 15, wherein the edge system is a first edge system, the method further comprising:
determining a third set of capabilities of a second edge system;
generating, based on the second set of capabilities of the first neural network, based on the first set of capabilities of the first edge system, based on the third set of capabilities of the second edge system, and based on the schema, a third neural network that is a simplified version of the first neural network and differs from the second neural network; and
deploying the third neural network onto the second edge system.

17. The method of claim 15, further comprising generating the second neural network based on environmental context around the edge system or one or more tasks that the edge system is to perform.

18. The method of claim 15, further comprising:
determining that the second neural network is unsynchronized with the first neural network after a period of the second neural network being disconnected from the first neural network; and
upon the second neural network connecting to the first neural network, synchronizing the second neural network with the first neural network.

19. The method of claim 15, further comprising:
transmitting an edge runtime to the edge system, wherein the edge runtime is configured to unpack and execute the second neural network on the edge system.

20. The method of claim 15, further comprising updating the second neural network by:
generating, based on the first set of capabilities of the edge system, based on the second set of capabilities of the first neural network, based on new environmental factors, and based on the schema, an updated second neural network; and
deploying the updated second neural network onto the edge system.
